(19) United States
(12) Patent Application Publication
(10) Pub. No.: US 2010/0057239 A1
(43) Pub. Date: Mar. 4, 2010

(54) SEMICONDUCTOR MANUFACTURING APPARATUS

(76) Inventors: Keisuke MASUDA, Toyama (JP); Takamasa Nozu, Toyama (JP)

Correspondence Address: MCDERMOTT WILL & EMERY LLP, 600 13TH STREET, NW, WASHINGTON, DC, 20005-3096, US

(21) Appl. No.: 12/547,970

(22) Filed: Aug. 26, 2009

(30) Foreign Application Priority Data
Aug. 29, 2008 (JP) 2008-220918

(51) Int. Cl. G06F 19/00

(52) U.S. Cl. 700/105

(57) ABSTRACT

It is determined whether or not a previously received wafer process condition can be changed to a newly received wafer process condition based on a wafer operation progress indicating which wafer is treated or untreated among a given number of wafers in a previously received lot process condition table when a new lot process condition table containing wafer process conditions corresponding to wafer identification information and having the wafer identification information all equal to wafer identification information in the previously received lot process condition table. When any wafer process condition is changeable, the wafer process condition is changed to the newly received wafer process condition. In this way, a semiconductor manufacturing apparatus can have increased yields in accordance with wafers.

### CROSS-REFERENCE TO RELATED APPLICATION

The disclosure of Japanese Patent Application No. 2008-220918 filed Aug. 29, 2008 including specification, drawings and claims is incorporated herein by reference in its entirety.

### BACKGROUND OF THE INVENTION

1. Field of the Invention

The present invention relates to a semiconductor manufacturing apparatus and more specifically to a semiconductor manufacturing apparatus that allows a process condition to be changed on a wafer basis when a new process condition for a lot is received and further allows for an interrupt processing and a priority execution of a new process condition for a lot having high priority.

2. Description of the Related Art

In the semiconductor manufacturing apparatus for performing given treatments on semiconductor wafers (substrates), one or multiple wafers are treated in a single operation. Wafer process conditions are assigned and controlled on a basis of a lot consisting of a given number of wafers. Such a semiconductor manufacturing apparatus acquires a lot process condition set by a user from an external facility communicably connected to the semiconductor manufacturing apparatus before treating the wafers in the lot. Then, the treatment is performed according to the lot process condition for the lot. In other words, one lot is treated under one lot process condition.

How the semiconductor manufacturing apparatus treats wafers based on the lot process condition will be described hereafter with reference to drawings. FIG. 12 is an illustration showing a conventional manufacturing system configuration for treating each of wafers under a lot process condition.

As shown in FIG. 12, this manufacturing system has a process control system 1201 (advance process control system: APC system) on a network path between a manufacturing execution system (MES) 1202 having an overall control including a lot control and a manufacturing apparatus 1203 for treating wafers. The process control system 1201 adjusts the lot process condition set by a user in the manufacturing execution system 1202 to a process condition for each wafer of the lot in accordance with a wafer condition of each wafer and sends each wafer process condition to the manufacturing apparatus 1203.

The wafer process condition sent from the process control system 1201 to the manufacturing apparatus 1203 is obtained as follows. The process control system 1201 accesses a database 1204 in which treatment results in previous processing steps that are measured by an inspection apparatus 1205 are accumulated and acquires data regarding each wafer to be treated. Then, a predetermined programmed algorithm is used to calculate the wafer process condition from the lot process condition. The wafer is treated under the calculated wafer process condition (for example, see the Japanese Laid-Open Patent Application Publication No. 2006-202821).

In the semiconductor manufacturing apparatus performing a treatment according to a lot process condition stored in advance, a treatment for a high priority lot (interrupt processing) is realized as follows.

FIG. 13 is an illustration showing a conventional manufacturing system for performing a treatment of a high priority lot.

As shown in FIG. 13, multiple manufacturing apparatuses 1301 (Apparatus #A, Apparatus #B, Apparatus #C . . . ) and a manufacturing controller 1302 (manufacturing control server) are LAN-connected. Operation information on the multiple manufacturing apparatuses 1301 is collected by the manufacturing controller 1302. The operation information is periodically transferred and stored in a scheduler database 1303 (simulator). An external computer 1304 controls the manufacturing apparatuses and timing for introducing a high priority lot using a previously programmed algorithm based on the operation information stored in the scheduler database 1303 and treatment instructions sent from LAN-connected terminals 1305, and sends an instruction to introduce the high priority lot to a specific manufacturing apparatus (for example Apparatus #A) via the manufacturing controller 1302. The specific manufacturing apparatus that has received the instruction to introduce the high priority lot performs a given treatment on the lot, namely a given number of wafers, based on the introduction instruction (for example, the Japanese Laid-Open Patent Application Publication No. 2002-23823).

### SUMMARY OF THE INVENTION

With the technology described in the Japanese Laid-Open Patent Application Publication No. 2006-202821, because the process condition of each wafer is calculated by adjusting the process condition for the lot, the wafer can be treated in accordance with the wafer state at an end of the previous processing step. However, for changing the lot process condition itself for a specific lot, the changed lot process condition should be set in the process control system 1201 in advance. In other words, once the treatment starts on the lot, the lot process condition cannot be adjusted or changed until all wafers in the lot are treated. For example, a problem is that it is not allowed to obtain a state (treatment result) of a treated wafer in the same lot by the inspection apparatus 1205 and reflect the obtained treatment result of the wafer in the same lot on the processing in the manufacturing apparatus 1203 in real time.

Consequently, for changing the wafer process condition, previously accumulated old measurement results are used to change the process condition. Therefore, the wafer process condition itself cannot be changed to an optimized process condition by using the treatment result on the wafer in the same lot. Then, there is an urgent demand for technical improvement in regard to changing of the wafer process condition.

On the other hand, with the technology described in the Japanese Laid-Open Patent Application Publication No. 2002-23823, the specific manufacturing apparatus 1301 for treating a high priority lot is absolutely limited to a manufacturing apparatus immediately available for treating the lot at the time of the external computer 1304 receiving a signal for introducing a high priority lot. Therefore, for example, a problem is that it is not allowed to temporarily hold the treatment of a low priority lot and treat a high priority lot first in a case where some manufacturing apparatuses are treating low priority lots at the time of reception of the signal.

Consequently, the manufacturing apparatus eventually starts the treatment of a high priority lot after the treatment of a low priority lot ends. Then, possible delay occurs in a lead time of a high priority lot from a transmission of a wafer process condition of the lot to an output of the wafer treated under the process condition.

Furthermore, from recent prospective trend of wafers having larger diameters and finer structures, cost per wafer may be increased. Therefore, increase in a production yield on a wafer will become more important and a single wafer should be treated under an optimized condition as much as possible. It is further required to accommodate changes in a state of the semiconductor manufacturing apparatus in real time, treat wafers under conditions in which the latest measurement results are reflected and fine-adjust the conditions.

The present invention is made in order to resolve the above problems and the purpose of the present invention is to provide a semiconductor manufacturing apparatus that allows a process condition to be changed on a wafer basis when a new lot process condition is received and further allows interruption and priority execution of a new lot process condition having high priority.

In order to resolve the above problems and achieve the above purpose, a semiconductor manufacturing apparatus of the present invention has adopted the following technical means. Here, the semiconductor manufacturing apparatus is supposed to be a semiconductor manufacturing apparatus in which a given number of wafers constitute a lot and the given number of wafers is treated based on a lot process condition table obtained from an external apparatus.

The semiconductor manufacturing apparatus relating to the present invention comprises a unit configured to receive a new lot process condition table containing wafer process conditions corresponding to wafer identification information each of wafers in one lot and having the wafer identification information all equal to wafer identification information in a previously received lot process condition table for the lot. The semiconductor manufacturing apparatus further comprises a unit configured to determine whether or not a previously received wafer process condition in the previously received lot process condition table can be changed to a newly received wafer process condition in the new lot process condition table based on a wafer operation progress indicating which wafer is treated or untreated among the given number of wafers in the previously received lot process condition table. The semiconductor manufacturing apparatus further comprises a unit configured to change the previously received wafer process condition to the newly received wafer process condition when any wafer process condition is changeable.

A “lot” is a unit consisting of a given number of wafers. The given number can be any number selected as appropriate. The given number can be selected for example based on a front opening unified pod (also called a carrier) in which wafers are kept and it can be the maximum number of wafers kept in a front opening unified pod.

A lot process condition table includes multiple process conditions associated with wafers in a lot. One process condition is associated with one wafer. The process condition includes, for example, parameters (heat treatment, processing time, processing temperature, etc.) regarding the treatment of a wafer. The parameters can be items (such as heat treatment, cleaning, drying, etc.) or numerical values (such as 5 min for the processing time and 90° C. for the processing temperature). The process condition may include, for example, the processing time and temperature for heat treatment (such as a chamber temperature in the case of a treatment in a unit chamber) and other additional conditions where necessary. The process condition can be changed where necessary according to the treatment mode (cleaning, drying, etc.).

The wafer identification information is information with which a specific wafer can be identified and, for example, corresponds to the wafer ID “WAFER01” that is an identifier for identifying a wafer.

The method for determining whether or not the wafer process condition can be changed is not particularly restricted and, for example, can comprise the steps of distinguishing treated wafers from untreated wafers using the wafer operation progress obtained by detecting the wafer processing state in the semiconductor manufacturing apparatus in real time after one wafer is treated and deeming that the untreated wafers are the changeable wafers.

The above semiconductor manufacturing apparatus can further comprise a unit configured to send a finding of changeability to the external apparatus after it is determined whether or not the previously received wafer process condition can be changed to the newly received wafer process condition.

The method of sending the finding of changeability is not particularly restricted and, for example, can comprise the steps of creating a table in which multiple wafers to be treated are associated with their finding of process condition changeability and sending the table to the external apparatus.

The above semiconductor manufacturing apparatus can further comprise a unit configured to determine whether or not a transfer of a wafer to a process chamber is held before the wafer is treated based on a waiting call that is information associated with the wafer identification information of the wafer in the process condition table and indicating that the transfer of the wafer to the process chamber is held or not. In such a case, a unit configured to hold the transfer of the wafer to the process chamber for a given period of time associated with the wafer identification information of the wafer when it is determined that the transfer of the wafer to the process chamber is held can be provided.

The waiting call which is information indicating that the transfer of a wafer to the process chamber is held or not can be any information. For example, the waiting call can be “W” for indicating that the transfer of the wafer to the process chamber is held and “−” for indicating that the transfer of the wafer to the process chamber is not held. Besides, characters, figures, and legend such as “o” and “x” can be used.

Holding the transfer of a wafer to the process chamber means that the semiconductor manufacturing apparatus temporarily holds a series of transfer/treatment regarding the wafer, including, for example, holding of the transfer of the wafer to the process chamber and discontinuation of the treatment of the wafer, and the semiconductor manufacturing apparatus being brought in a standby mode for a given period of time. When the transfer of the wafer to the process chamber is held, the transfer/treatment of the subsequent wafer can be held or the transfer/treatment of the previous and subsequent wafers can be held.

The given period of time refers to a waiting time for which the semiconductor manufacturing apparatus is in a standby mode and also called the timeout period. The timeout period can be changed by a user (other semiconductor manufacturing apparatuses) where necessary on an arbitrary basis. The timeout period can be, for example, 3 min, 5 min, or 10 min depending on the lead time.

In another aspect of the present invention, a semiconductor manufacturing apparatus is supposed to be a semiconductor manufacturing apparatus in which a given number of wafers constitute a lot and the given number of wafers is treated based on a lot process condition table obtained from an external apparatus.

This semiconductor manufacturing apparatus can comprises a unit configured to receive a new lot process condition table containing wafer process conditions corresponding to wafer identification information each of wafers in one lot and having the wafer identification information all different from wafer identification information in a previously received lot process condition table for a lot. The semiconductor manufacturing apparatus further comprises a unit configured to compare a priority information indicating a priority of a wafer treatment associated with the identification information of untreated wafers among the wafers in the previously received lot process condition table with the priority information associated with the wafer identification information of wafers in the newly received process lot condition table based on a wafer operation progress indicating which wafer is treated or untreated among the given number of wafers in the previously received lot process condition table. The semiconductor manufacturing apparatus further comprises a unit configured to give priority in execution to the lot process condition table having the wafer identification information of higher priority wafers as a result of the priority information comparison.

The priority information indicating the priority of wafer treatment can be any information as long as it shows which wafers have higher or lower priorities. For example, when the alphabet is used as priority information, the letter “A” indicates the highest priority and the letter “B” indicates the priority next to “A”. Alternatively, the numbers (such as “1,” “2,” “3,” etc.) can be used for giving priorities.

The above semiconductor manufacturing apparatus can further comprise a unit configured to temporarily hold a treatment in progress based on the previously received lot process condition table and to give priority in execution to the newly received lot process condition table when the priority information comparison results show that the lot process condition table having the wafer identification information of higher priority wafers is the newly received lot process condition table.

The temporal holding means that the treatment is temporarily held on a wafer basis since the treatment is performed on a wafer basis. For example, when the treatment of a wafer is in progress when a new process condition table is received, the treatment/transfer of the next wafer is temporarily held. The treatment of the wafer in progress is completed.

Furthermore, a unit configured to send a finding of temporarily held wafers to the external apparatus when the treatment in progress based on the previously received lot process condition table is held can be provided.

The finding of temporarily held wafers refers to untreated wafer as a result of temporal holding. The method of sending the finding of temporarily held wafers is not particularly restricted and, for example, can comprise the step of sending to the external apparatus a table in which the wafer identification information and the temporal holding information are associated and stored. Another table, for example in which the identification information of untreated wafers of which the treatment is temporarily held and the identification information of treated wafers are associated and stored can be used.

The above semiconductor manufacturing apparatus can further comprise a unit configured to send a finding of executed process condition to the external apparatus for each wafer after a given treatment is performed on a wafer among the given number of wafers in a lot.

The semiconductor manufacturing apparatus can have multiple loading ports. The loading port is a machine transferring a wafer between the pod in which the wafers are kept and a manufacturing apparatus interface without exposing the wafer to the ambient air (atmosphere) in a semiconductor manufacturing process.

The semiconductor manufacturing apparatus can transfer wafers one by one from the pod (carrier) in which the wafers are kept to the chamber where the wafers are treated via units constituting a wafer transfer path using a robot.

The semiconductor manufacturing apparatus can utilize, as the new lot process condition sent from the external apparatus, a lot process condition in which values calculated by given arithmetic operations using measurement data obtained in a preceding or subsequent measuring step of the semiconductor manufacturing apparatus are reflected.

The semiconductor manufacturing apparatus can utilize, as the wafer-associated priority sent from the external apparatus, the priority in which the lot due date (wafer due date) calculated by a system controlling an entire lot operation progress in the semiconductor manufacturing plant is reflected.

The semiconductor manufacturing apparatus of the present invention determines whether or not the previously received wafer process condition can be changed to the newly received wafer process condition based on the wafer operation progress when it receives a new lot process condition table having the wafer identification information all equal to the wafer identification information in the previously received lot process condition table. The semiconductor manufacturing apparatus further changes the wafer process condition to the newly received wafer process condition when any wafer process condition is changeable.

In this way, when there are any untreated wafers among the given number of wafers in the previously received lot process condition table based on the wafer operation progress, the process conditions of such wafers are deemed to be changeable and changed to the newly received wafer process conditions. Therefore, the process condition can be changed on a wafer basis in accordance with the wafers of which a processing state changes in real time using the wafer operation progress although a process condition table can be changed on a lot basis in the conventional art. For example, a process condition based on new wafer measurements (optimized process condition) can be reflected in the treatment of wafers in the lot in process. Consequently, the quality of treated wafers is improved and the production yield that is a ratio of non-defective wafers to all treated wafers can be increased. Furthermore, since the process condition can be changed on a wafer basis, small changes in the process condition (fine adjustment) can easily be made.

The unit configured to send to the external apparatus the finding of changeability after it is determined whether or not the previously received wafer process condition can be changed to the newly received wafer process condition can further be provided.

In this way, a user or other semiconductor manufacturing apparatuses can know whether or not the wafer process condition is changed through the external apparatus. Furthermore, a subsequent action plan can easily be made based on the finding of changeability and unexpected problems can promptly be handled.

Furthermore, the semiconductor manufacturing apparatus of the present invention determines whether or not the transfer of a wafer to the process chamber is held before the wafer is treated based on the waiting call associated with the wafer identification information of the wafer in the lot process condition table. Then, the semiconductor manufacturing apparatus holds the transfer of the wafer to the process chamber for the given period of time associated with the wafer identification information of the wafer when it is determined that the transfer of the wafer to the process chamber is held.

In this way, the transfer of a wafer to the process chamber is held for a given period of time for predetermined wafers, whereby the semiconductor manufacturing apparatus can easily receive a new lot process condition table set by a user. Then, there is enough time to change the previously received wafer process condition and a process condition based on new wafer measurements (optimized process condition) can easily be reflected in the treatment of wafers. Consequently, the quality and production yield of wafers can more easily be improved.

Furthermore, the semiconductor manufacturing apparatus of the present invention compares the priority information associated with the wafer identification information of untreated wafers among the wafers in the previously received lot process condition table with the priority information associated with the wafer identification information of wafers in the newly received lot process condition table based on the wafer operation progress when it receives a new process condition table having the wafer identification information all different from the wafer identification information in the previously received lot process condition table. Then, the semiconductor manufacturing apparatus gives priority in execution to the lot process condition table having the wafer identification information of higher priority wafers as a result of the priority information comparison.

In this way, when the semiconductor manufacturing apparatus receives a new process condition table for a lot different from the previously received lot, the semiconductor manufacturing apparatus gives priority in execution to the lot process condition table for the lot having higher priority wafers. Therefore, when there are any wafers to which a given process condition should immediately be applied or wafers of which the treatment is urgent, the semiconductor manufacturing apparatus allows for interruption and prompt execution of the lot process condition table for the lot to which such wafers belongs.

The above semiconductor manufacturing apparatus can be so configured as to temporarily hold the treatment in progress based on the previously received lot process condition table and give priority in execution to the newly received lot process condition table when the priority information comparison results show that the lot process condition table having the wafer identification information of higher priority wafers is the newly received lot process condition table.

In this way, the treatment of lower priority wafers is temporarily held and the treatment of higher priority wafers can be treated first in a semiconductor manufacturing apparatus specified by a user. Then, any disturbance or variations in individual semiconductor manufacturing apparatuses are prevented and the wafers can be treated in a semiconductor manufacturing apparatus intended by a user. Any delay in the lead time of high priority wafers is eliminated and urgent wafer treatment can promptly be handled.

The above semiconductor manufacturing apparatus can be so configured as to send the finding of temporarily held wafer process condition to the external apparatus when the treatment in progress based on the previously received lot process condition table is temporarily held.

In this way, a user can easily know information on the temporarily held wafer that occurs as a result of interruption of new high priority wafers. Furthermore, the subsequent action plan can easily be made and unexpected problems can promptly be handled.

The above semiconductor manufacturing apparatus can be so configured as to send the finding of executed process condition to the external apparatus for each wafer after a given treatment is performed on a wafer among a given number of wafers in a lot.

In this way, a user can know an actually executed process condition for each wafer even in a cases in which the wafer process condition is changed or higher priority wafers are treated. Then, a user can notice unexpected problems with wafers earlier and easily make the subsequent action plan, improving the quality and production yield of wafers.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustration showing a system configuration of a semiconductor manufacturing apparatus in an embodiment relating to the present invention.

FIG. 2 is a flowchart showing an execution procedure in the first embodiment relating to the present invention.

FIG. 3 is an illustration showing an example of a process condition table in the first embodiment relating to the present invention.

FIG. 4 is an illustration showing an example of an execution table in the first embodiment relating to the present invention.

FIG. 5 is an illustration showing an example of a processing state table in the first embodiment relating to the present invention.

FIG. 6 is an illustration showing an example of a changed process condition table in the first embodiment relating to the present invention.

FIG. 7 is an illustration showing an example of a return table in the first embodiment relating to the present invention.

FIG. 8 is a flowchart showing an execution procedure in the second embodiment relating to the present invention.

FIG. 9 is an illustration showing an example of a new process condition table in the second embodiment relating to the present invention.

FIG. 10 is an illustration showing an example of a new process condition table in the second embodiment relating to the present invention.

FIG. 11 is an illustration showing an example of a temporary held operation execution history table in the second embodiment relating to the present invention.

FIG. 12 is an illustration showing a conventional manufacturing system for changing process conditions.

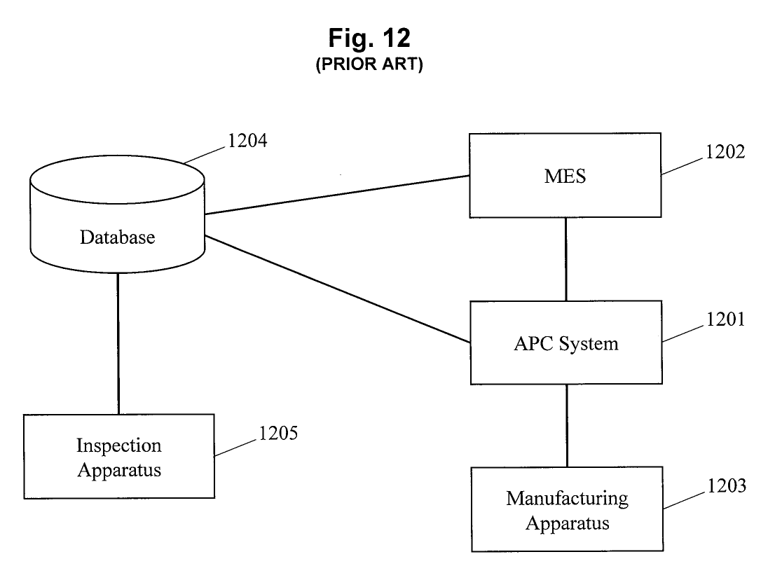

FIG. 13 is an illustration showing a conventional manufacturing system for introducing a high priority lot.

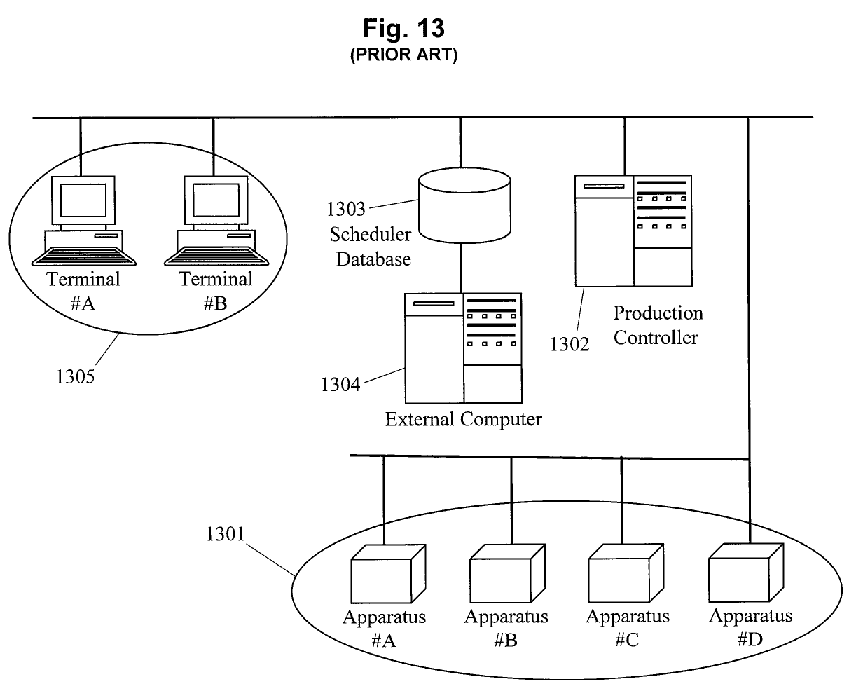

### DETAILED DESCRIPTION OF PREFERRED EMBODIMENTS

The present invention will be described hereafter with reference to the drawings showing embodiments of the present invention.

### <Semiconductor Manufacturing Apparatus>

Embodiments of the present invention will be described hereafter with reference to the drawings.

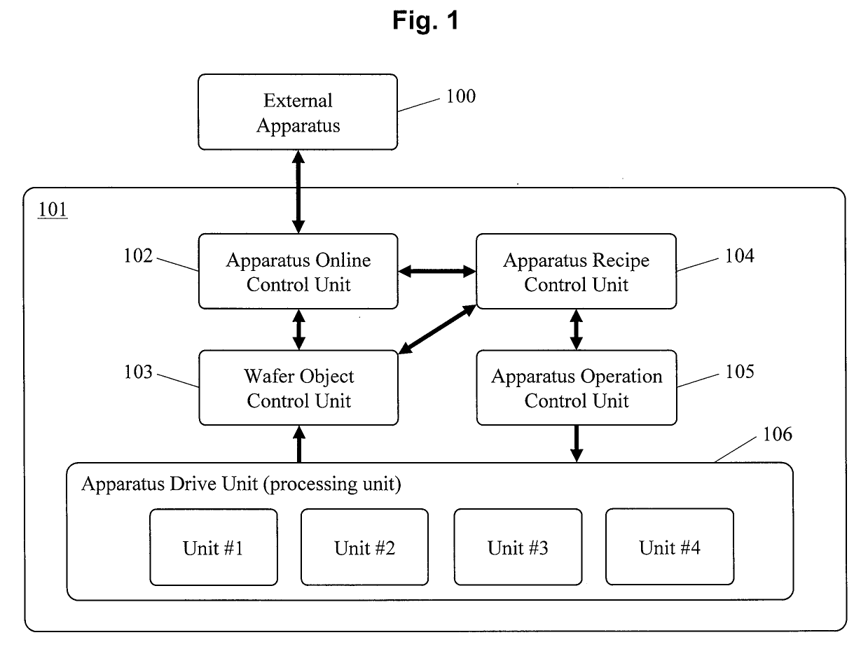

FIG. 1 is an illustration showing a system configuration of a semiconductor manufacturing apparatus in an embodiment of the present invention. In FIG. 1, details of components having no direct relevance to the present invention will be omitted.

A semiconductor manufacturing apparatus 101 of this embodiment comprises an apparatus online control unit 102, a wafer object control unit 103, an apparatus recipe control unit 104, an apparatus operation control unit 105 and an apparatus drive unit 106.

The semiconductor manufacturing apparatus 101 is communicably connected to an external apparatus 100. The external apparatus 100 is, for example, a manufacturing execution system (MES) controlling a semiconductor production line to which the semiconductor manufacturing apparatus 101 belongs. The apparatus online control unit 102 communicates with the external apparatus 100 via a LAN-connected network. The wafer object control unit 103 manages and keeps (stores) data, on a wafer basis, such as an operation progress of each wafer in a lot currently in process in the semiconductor manufacturing apparatus 101, position of the wafer within the semiconductor manufacturing apparatus 101 and operation history in the semiconductor manufacturing apparatus 101, etc. The apparatus recipe control unit 104 exchanges data with the external apparatus 100 via the apparatus online control unit 102, acquires data stored in the wafer object control unit 103, sends orders/instructions to the apparatus operation control unit 105 and keeps (stores) process conditions, on a lot basis, sent from the external apparatus 100. The apparatus operation control unit 105 actually controls the operation of the apparatus drive unit (processing unit) 106 of the semiconductor manufacturing apparatus 101 according to the process condition stored in the apparatus recipe control unit 104. The apparatus drive unit 106 actually retrieves wafers one by one from a carrier in which the wafers are kept and performs a predetermined treatment (for example cleaning, heating or drying operations, etc.).

Here, a “lot” is a unit consisting of a given number of wafers (for example 24 wafers; also referred to as a wafer group of 24 slices). The given number is set, for example, for the maximum number of wafers kept in a front opening unified pod. Furthermore, the apparatus drive unit 106 comprises two chambers where predetermined treatments are performed, multiple units constituting a wafer transfer path (Unit #1, Unit #2, Unit #3, Unit #4, etc) and a carrier in which a given number of wafers in a lot are kept.

The units of the semiconductor manufacturing apparatus 101 can be realized by, for example, an exclusive-use calculation circuit, or hardware having a processor and memories such as RAM (random access memory) or ROM (read only memory), etc. and software stored in the memories and operating on the processor.

### First Embodiment

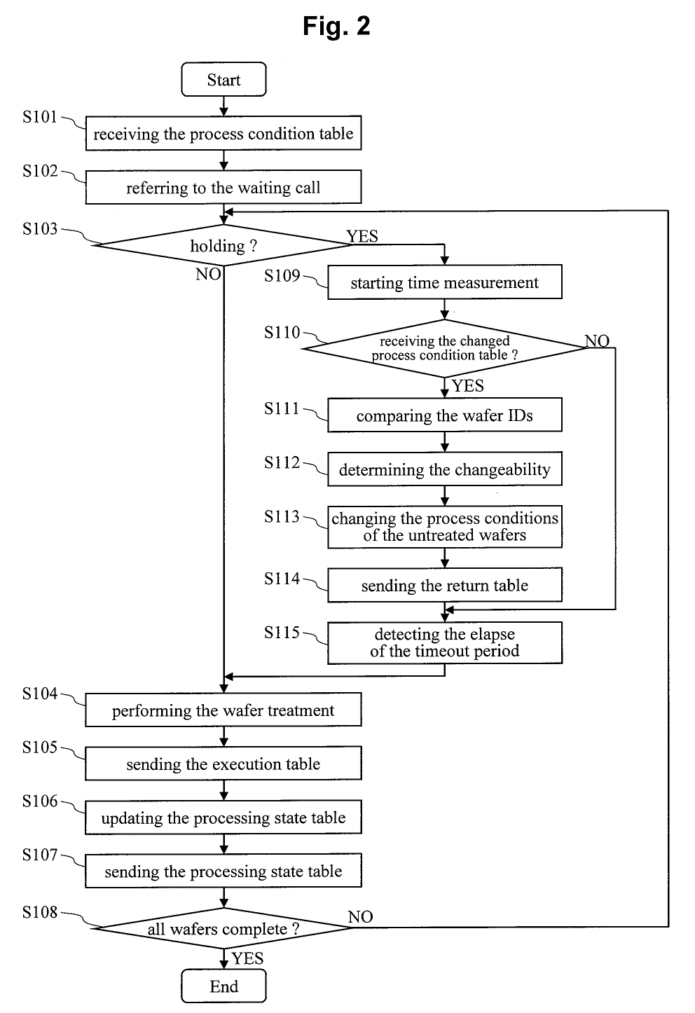

A procedure to change a process condition on a wafer basis when the semiconductor manufacturing apparatus 101 of a first embodiment receives a new lot process condition from the external apparatus 100 will be described hereafter with reference to FIGS. 1 to 7. FIG. 2 is a flowchart showing an execution procedure in the first embodiment. Details of components having no direct relevance to the first embodiment will be omitted.

Before the apparatus operation control unit 105 of the semiconductor manufacturing apparatus 101 retrieves a wafer among multiple wafers in the carrier and starts to treat the wafer, a process condition table set by a user and in which each wafer in a lot is associated with a process condition is sent from the external apparatus 100 to the apparatus online control unit 102 of the semiconductor manufacturing apparatus 101.

When the apparatus online control unit 102 receives the process condition table, the apparatus recipe control unit 104 receives the process condition table via the apparatus online control unit 102 and keeps (stores) the process condition table (FIG. 2: S101).

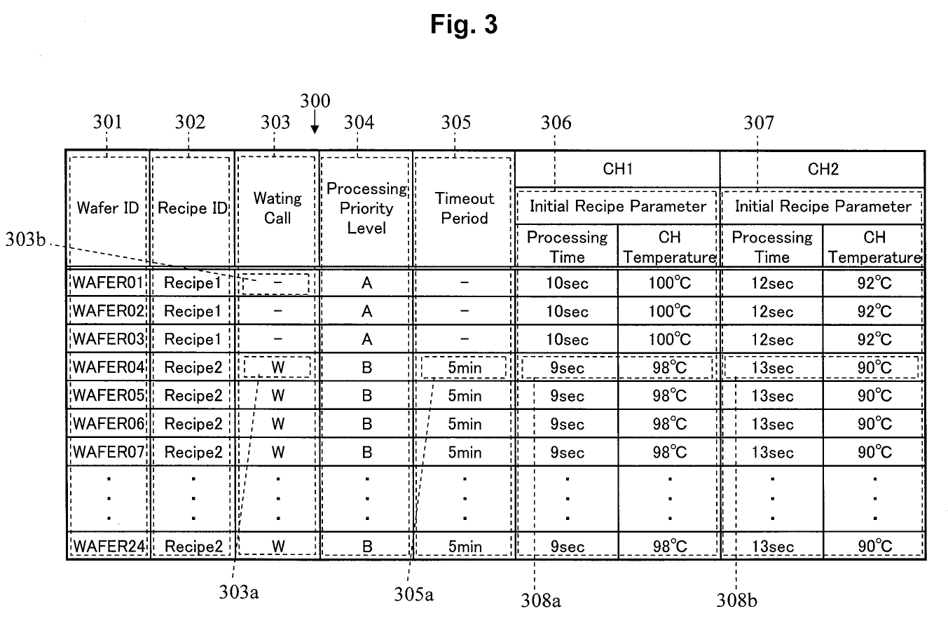

In the process condition table 300, as shown in FIG. 3, a wafer ID 301, a recipe ID 302, a waiting call 303, a processing priority level 304, a timeout period 305, a first chamber (CH1) initial recipe parameter 306 and a second chamber (CH2) initial recipe parameter 307 are associated and stored.

The wafer ID 301 is an identifier for identifying a wafer. The recipe ID 302 is an identifier for identifying a given process condition among multiple wafer process conditions created by a user in advance. The waiting call 303 is information as to whether or not a transfer of a wafer to be treated to the chamber is held before the treatment for the wafer is started. For example, a symbol “W” 303a is associated and stored when the transfer of the wafer to the chamber is held and a symbol “−” 303b is associated and stored when the transfer of the wafer to the chamber is not held. The processing priority level 304 is a label indicating that the wafer is given priority in treatment among multiple wafers. The timeout period 305 indicates a period of time for which the transfer of the wafer to the chamber is held. Here, the number of wafer IDs 301 associated and stored in the process condition table is up to the number of wafers in a lot, for example up to 24.

The chamber is a process chamber in which a wafer is subject to a predetermined treatment. For example, when the apparatus drive unit of the semiconductor manufacturing apparatus has two chambers, each wafer is transferred to the first chamber and the second chamber in sequence and subject to a predetermined treatment in each of them, or each wafer is transferred to only one of the chambers for one and only predetermined treatment. It is a matter of design changed according to a type of wafers to be treated whether a wafer is treated in each chamber or a wafer is transferred either one of the first and second chambers for only one treatment.

In this embodiment, each wafer is treated in the first chamber and in the second chamber in sequence. Therefore, a wafer is transferred to the first chamber and treated therein and subsequently transferred to the second chamber and treated therein.

The initial recipe parameters 306 and 307 are parameters regarding the process condition of a wafer among a given number of wafers in a lot, such as a processing time for which the wafer is held in the chamber and a CH temperature that is a processing temperature in the chamber. Other process conditions can additionally be provided. Here, each wafer is subject to heat treatment.

The holding of the transfer of a wafer to the process chamber (the chamber) means that the transfer of a wafer is suspended or the wafer is waiting in front of the chamber. Once the transfer of a wafer to the process chamber is held, the transfer/treatment of subsequent wafers is held. On the other hand, a wafer preceding the wafer of which the transfer to the process chamber is held is transferred and treated.

Based on the process condition table 300, the apparatus recipe control unit 104 allows the apparatus operation control unit 105 to execute the treatment using the process condition in accordance with a specific wafer and to determine whether or not the transfer of a wafer to the chamber is held before the wafer is treated.

Receiving the process condition table 300, the apparatus recipe control unit 104 refers to the waiting call corresponding to the wafer ID “WAFER01” stored in the first row of the process condition table 300 and determines whether or not the transfer of the wafer to the first chamber is held (FIG. 2: S102, S103).

As shown in FIG. 3, the symbol “−” 303b is associated and stored in the waiting call of the wafer ID “WAFER01” in the process condition table 300. Therefore, the apparatus recipe control unit 104 deems that it is unnecessary to hold the transfer of the wafer having the wafer ID “WAFER01” to the first chamber and immediately sends to the apparatus operation control unit 105 a signal for performing the treatment on the wafer having the wafer ID “WAFER01” (FIG. 2: S103 NO).

Receiving the signal, the apparatus operation control unit 105 acquires from the process condition table 300 the process condition corresponding to the wafer ID “WAFER01” (here, the CH1 initial recipe parameter 306 and CH2 initial recipe parameter 307) and starts (performs) the wafer treatment according to the condition (FIG. 2: S104).

For example, the wafer corresponding to the wafer ID “WAFER01” is transferred to the first chamber via units constituting the transfer path and treated therein according to the CH1 initial recipe parameter 306 (the processing time “10 sec” and CH temperature “100° C.”). Then, it is transferred to the second chamber and treated therein according to the CH2 initial recipe parameter 307 (the processing time “12 sec” and CH temperature “92° C.”).

When the apparatus drive unit 106 completes the treatment on the wafer, the wafer object control unit 103 sends a finding of process condition actually executed on the wafer to the apparatus recipe control unit 104. The apparatus recipe control unit 104 sends the received finding of wafer process condition to the external apparatus 100 via the apparatus online control unit 102 (FIG. 2: S105).

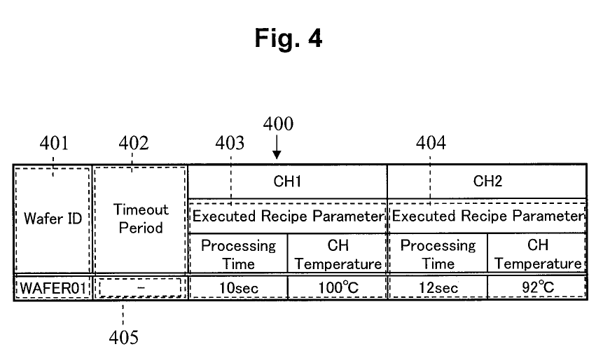

The finding of wafer process condition is sent, for example as shown in FIG. 4, in the form of an execution table 400 in which a wafer ID 401 “WAFER01” that is the identifier of the treated wafer, a timeout period 402 corresponding to the wafer ID and a CH1 executed recipe parameter 403 and a CH2 executed recipe parameter 404 corresponding to the process condition for the wafer ID 401 are associated and stored.

In the above case, the CH1 executed recipe parameter 403 is the processing time “10 sec” and CH temperature “100° C.” and corresponds to the CH1 initial recipe parameter. The CH2 executed recipe parameter 404 is the processing time “12 sec” and CH temperature “92° C.” and corresponds to the initial CH2 recipe parameter.

Here, the transfer of the wafer having the wafer ID “WAFER01” is not held before the wafer is treated. Therefore, a symbol “−” 405 indicating the waiting time “0” or no waiting time is associated and stored in the timeout period 402.

Furthermore, in this embodiment of the present invention, the first and second chambers are used for one wafer. For example, only the first chamber can be used for one wafer. In such a case, the second chamber is not used and the process condition associated with the second chamber can be eliminated in the execution table.

A user or other semiconductor manufacturing apparatuses can confirm the actually executed wafer ID and process condition based on the execution table 400 each time the wafer treatment is completed.

When the apparatus drive unit 106 completes the transfer of the wafer, the apparatus drive unit 106 rewrites (updates) the processing state table that is a table showing a wafer operation progress (a wafer processing state) stored in the wafer object control unit 103 (FIG. 2: S106).

The transfer of a wafer is, for example, the transfer of a wafer from the carrier in which untreated wafers are kept to the first chamber, from the first chamber to the second chamber, and from the second chamber to the carrier in which treated wafers are kept.

When one wafer is transferred from some place and the place becomes available for the subsequent wafer being transferred, the apparatus drive unit 106 transfers the subsequent wafer to that place in sequence. For example, when a wafer is treated in the first chamber and transferred to the second chamber, the apparatus drive unit 106 transfers the subsequent wafer to the first chamber in sequence.

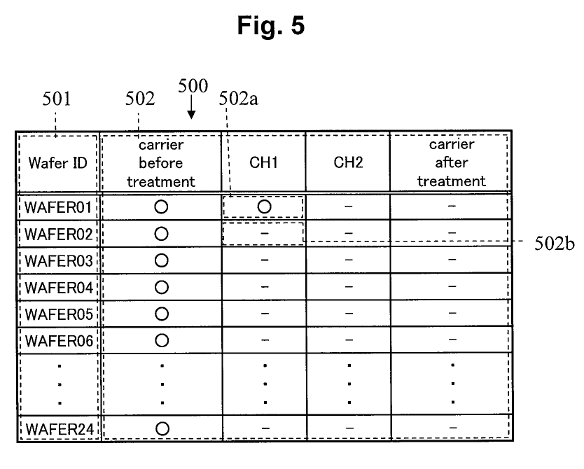

As shown in FIG. 5, in the processing state table 500, a wafer ID 501 that is the identifier of a wafer to be treated by the apparatus drive unit 106 and transfer fields 502 that are fields indicating a place (position) to which the wafer is transferred are associated and stored. For example, “carrier before treatment”, “first chamber”, “second chamber” or “carrier after treatment” are associated and stored in the transfer fields 502 to which the wafer is transferred, presenting the transfer path along which a wafer placed in the carrier is transferred via a given number of units and treated in the sequence of the first chamber and second chamber, and returned to another carrier.

In this embodiment, a symbol “o” 502a indicating that the wafer has already been transferred to the transfer field or a symbol “−” 502b indicating that the wafer has not been transferred to the transfer field is stored in the transfer fields 502. The apparatus drive unit 106 rewrites the processing state table 500 each time the wafer is transferred and the apparatus recipe control unit 104 can know where a specific wafer is on the transfer path of the apparatus drive unit 106 (transfer state or progress state) based on the processing state table 500. It can also be known whether a specific wafer is treated or untreated according to where the specific wafer is.

In this embodiment of the present invention, the “carrier before treatment”, “first chamber”, “second chamber” and “carrier after treatment” are associated and stored in the transfer fields 502 of the processing state table 500. For example, a unit name each of units on the transfer path (for example, Unit #1, Unit #2, Unit #3, Unit #4, Unit #2 or Unit #1, etc) can be associated and stored in the transfer fields for more detailed transfer state of each wafer.

For example, as shown in FIG. 5, when the symbol “o” is stored the transfer field “CH1 (first chamber)” corresponding to “WAFER01,” the wafer having the wafer ID “WAFER01” is treated in the first chamber. Then, the apparatus drive unit 106 transfers the wafer from the first chamber to the second chamber after the completion of the treatment and replaces the symbol “o” with the symbol “−” in the transfer field “CH2 (second chamber)” corresponding to “WAFER01” in the processing state table 500 stored in the wafer object control unit 103.

In the rewritten processing state table 500, the wafers having the wafer IDs in the transfer field “CH1” (or “CH2”) of which the symbol “o” is not associated and stored, in other words the wafer IDs only in the transfer field “carrier before treatment” of which the symbol “o” is associated and stored (for example, “WAFER02” to “WAFER24”) are untreated wafers.

After the processing state table 500 is rewritten, the wafer object control unit 103 sends the rewritten processing state table 500 to the external apparatus 100 via the apparatus online control unit 102 (FIG. 2: S107). With the above configuration, a user or other semiconductor manufacturing apparatuses can know the progress each of the wafers and lot to which the wafers belongs via the external apparatus 100 each time a wafer is transferred/treated.

The wafer object control unit 103 also sends a signal indicating the completion of wafer transfer to the apparatus recipe control unit 104. Receiving the signal, the apparatus recipe control unit 104 refers to the process condition table 300 and confirms the wafer to be treated next. Then, the apparatus recipe control unit 104 further refers to the waiting call corresponding to the wafer to be treated next (the wafer ID “WAFER02” in a case of numerical order of wafer ID) and determines whether or not the transfer of the wafer to the chamber is held (FIG. 2: S108 NO, S103).

For example, in the same manner as for the wafer ID “WAFER01” described above, the symbol “−” 303b is associated and stored in the waiting calls for the wafer IDs “WAFER02” and “WAFER03” in the process condition table 300 shown in FIG. 3. Therefore, the apparatus recipe control unit 104 deems that it is unnecessary to hold the transfer of the wafers “WAFER02” and “WAFER03” to the chamber. Then, the apparatus recipe control unit 104 immediately sends to the apparatus operation control unit 105 a signal for performing the treatment of the wafer having the wafer ID “WAFER02” (or “WAFER03”) at the time that the wafer having the wafer ID “WAFER02” (or “WAFER03”) is treated. Then, each wafer is treated in sequence in the same manner as the wafer ID “WAFER01”, which is not described here.

Next, a case in which the symbol “W” 303a is associated and stored in the waiting call corresponding to the wafer ID in the process condition table 300 will be described hereafter.

For example, after the wafer corresponding to the wafer ID “WAFER03” is transferred from the first chamber to the second chamber, the wafer object control unit 103 sends to the apparatus recipe control unit 104 a signal indicating that the transfer of the wafer corresponding to the wafer ID “WAFER03” to the second chamber is completed. Receiving the signal, the apparatus recipe control unit 104 refers to the process condition table 300 and confirms the wafer to be treated next. Then, the apparatus recipe control unit 104 further refers to the waiting call corresponding to the wafer to be treated next (the wafer ID “WAFER04” in the case of numerical order of wafer ID) and determines whether or not the transfer of the wafer to the first chamber is held (FIG. 2: S108 NO, S103).

The symbol “W” 303a is associated and stored in the waiting call 303 for the wafer ID “WAFER04” in the process condition table 300 shown in FIG. 3. Therefore, the apparatus recipe control unit 104 deems that it is necessary to hold the transfer of the wafer corresponding to the wafer ID “WAFER04” to the chamber (FIG. 2: S103 YES, S109).

Deeming that it is necessary to hold, the apparatus recipe control unit 104 acquires the timeout period for the wafer ID for which the transfer to the chamber is held from the process condition table 300. Then, a transmission of signals to the apparatus operation control unit 105 is held for the timeout period since the timeout period is acquired. In other words, the apparatus operation control unit 105 does not start to treat the wafer, holding the transfer of the wafer to the chamber (in wait).

In the process condition table 300 shown in FIG. 3, the timeout period corresponding to the wafer ID “WAFER04” is “5 min” 305a. In this case, the apparatus recipe control unit 104 acquires “5 min” 305a from the process condition table 300 and measures five minutes.

For example, it is assumed that the condition (treatment result) of a treated wafer in the same lot is obtained and the obtained treatment result of the treated wafer in the same lot is reflected on the processing in the semiconductor manufacturing apparatus 101 in real time, or the lot process condition table itself is changed for a specific lot. While the apparatus operation control unit 105 is waiting, the external apparatus 100 (for example a personal computer connected to the external apparatus 100) sends a new lot process condition table set by a user to the apparatus online control unit 102 and the apparatus recipe control unit 104 receives the new lot process condition table via the apparatus online control unit 102 (FIG. 2: S110 YES). For example, the new lot process condition table is received in the form of a table, as shown in FIG. 3, in which the processing time etc. in the initial recipe parameter of the above described process condition table 300 is changed to a new processing time etc. (a changed process condition table).

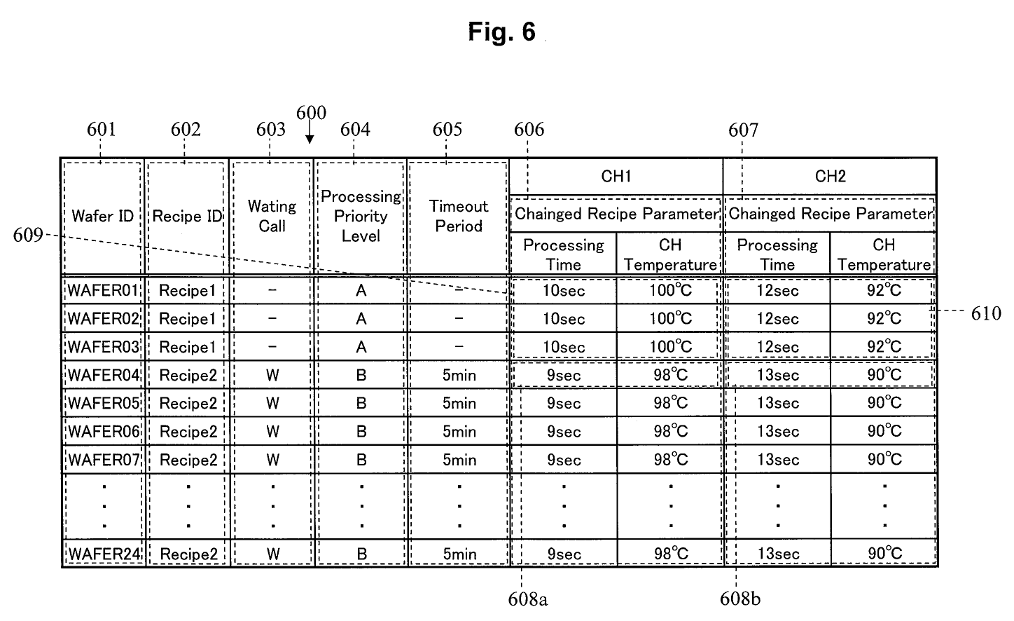

As shown in FIG. 6, the changed process condition table 600 has the same structure as the process condition table 300, in which a wafer ID 601, a recipe ID 602, a waiting call 603, a processing priority level 604, a timeout period 605, a changed CH1 recipe parameter 606, and a changed CH2 recipe parameter 607 are associated and stored. In the changed process condition table 600, the changed CH1 recipe parameter 606 and the changed CH2 recipe parameter 607 are newly entered (changed) by a user and the wafer IDs 601 are all equal to the wafer IDs 301 in the process condition table 300.

Receiving the new lot process condition table (the changed process condition table 600), the apparatus recipe control unit 104 determines whether or not the wafer IDs 301 in the previously received process condition table 300 are all equal to the wafer IDs 601 in the newly received changed process condition table 600 (FIG. 2: S111). This is done by comparing the wafer IDs in the tables and determining whether or not there are any wafer IDs that are the same.

The above determination is equal to determining whether the lot corresponding to the changed process condition table and the lot corresponding to the previously received process condition table are the same. Then, in another possible configuration, for example, a lot ID that is an identifier for identifying a lot is given to the process condition table and the lot IDs can be compared with each other to determine whether the lot corresponding to the changed process condition table and the lot corresponding to the previously received process condition table are the same.

As described above, the wafer IDs in the process condition table 300 and the wafer IDs in the changed process condition table 600 are all the same. In other words, these process condition tables correspond to the same lot. Therefore, the apparatus recipe control unit 104 deems that the wafer IDs in the process condition table 300 are all equal to the wafer IDs in the changed process condition table 600 and further determines whether or not the previously received wafer process condition (individual wafer process conditions in the process condition table 300) can be changed to the newly received wafer process condition (individual wafer process conditions in the process condition table 600) (FIG. 2: S112).

Moreover, when there is any wafer ID that is not common to the process condition table and the changed process condition table, the apparatus recipe control unit 104 deems that the changed process condition table belongs to a lot different from the previously received lot and continues to treat the wafers under the condition in the process condition table without changing. Then, when the treatment corresponding to the process condition table is all completed, the treatment corresponding to the newly received changed process condition table is performed.

For determining the changeability, the apparatus recipe control unit 104 refers to the processing state table stored in the wafer object control unit 103 and determines which wafers are treated or untreated (wafer operation progress) among the multiple wafers in the process condition table at the time of reception of the changed process condition table. In this determination, the apparatus recipe control unit 104 confirms untreated wafers (wafers that have been transferred to neither one of the first and second chambers) and deems that the process condition can be changed for the confirmed untreated wafers.

When the apparatus recipe control unit 104 receives the changed process condition table, in order words when the transfer of the wafer having the wafer ID “WAFER03” from the first chamber to the second chamber is completed, the wafer IDs “WAFER04” to “WAFER24” have the symbol “o” associated and stored only in their transfer field “carrier before treatment” of the processing state table. Therefore, it is deemed that the wafers having these wafer IDs are untreated and their process conditions can be changed.

Deeming that the wafers are untreated, the apparatus recipe control unit 104 changes the process conditions for the wafer IDs corresponding to the untreated wafers in the process condition table 300 to the process conditions for the wafer IDs corresponding to the untreated wafers in the changed process condition table 600 (FIG. 2: S113).

For example, for the untreated wafer ID “WAFER04,” the CH1 initial recipe parameter 308a (the processing time “11 sec” and CH temperature “105° C.”) and CH2 initial recipe parameter 308b (the processing time “14 sec” and CH temperature “88° C.”) in the process condition table 300 shown in FIG. 3 are changed to the changed CH1 recipe parameter 608a (the processing time “9 sec” and CH temperature “98° C.”) and changed CH2 recipe parameter 608b (the processing time “13 sec” and CH temperature “90° C.”) in the changed process condition table 600 shown in FIG. 6. Such changes are made for all changeable wafer IDs (wafer IDs of the untreated wafers).

Furthermore, the apparatus recipe control unit 104 provides a symbol “x” indicating that the process condition cannot be changed in the changed CH1 recipe parameter 609 and the changed CH2 recipe parameter 610 for the wafer IDs for which the process condition cannot be changed (the wafer IDs “WAFER01” to “WAFER03” in the process condition table 300, in other words the wafer IDs of the wafers that have been completely or partly treated) in the received changed process condition table 600. The apparatus recipe control unit 104 sends the changed process condition table with the symbol “x” to the external apparatus 100 via the apparatus online control unit 102 as a return table (FIG. 2: S114). The return table corresponds to the finding of changeability.

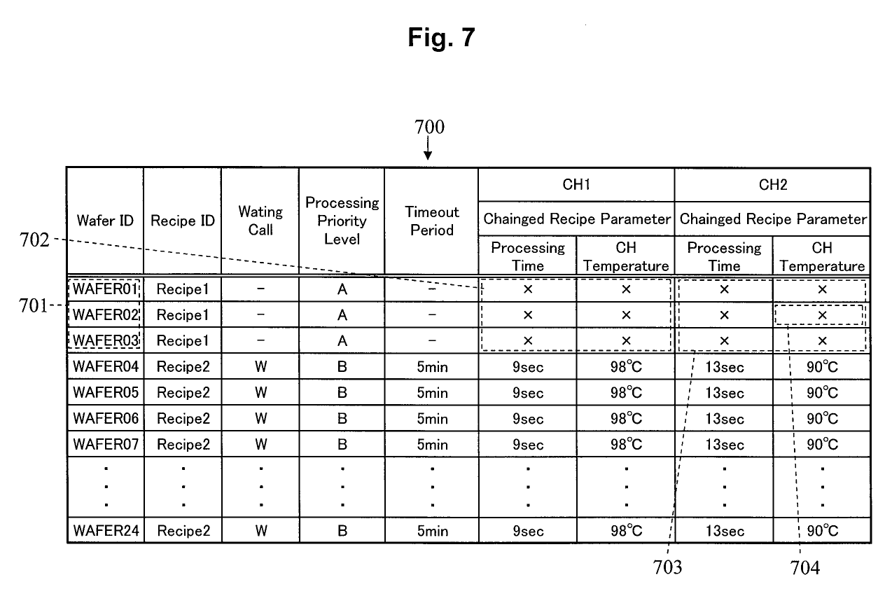

As shown in FIG. 7, the return table 700 has the symbol “x” 704 in the changed CH1 recipe parameter 702 and the changed CH2 recipe parameter 703 corresponding to the wafer IDs 701 “WAFER01” to “WAFER03” for which the change cannot be made.

Receiving the return table 700, the external apparatus 100 displays the return table 700 to a user. Alternatively, the external apparatus 100 can send the return table 700 to other semiconductor manufacturing apparatuses.

Any method can be used for the display. For example, the external apparatus 100 displays the return table 700 on a liquid crystal display provided thereto. With this configuration, a user or other semiconductor manufacturing apparatuses can know the finding of changeability on a wafer basis among the changed process condition and unchanged process condition (the new lot process condition table sent by the external apparatus 100 earlier).

When the apparatus recipe control unit 104 measuring the timeout period since while ago detects the elapse of the timeout period after the process condition is changed, the apparatus recipe control unit 104 sends to the apparatus operation control unit 105 a signal for performing the treatment on the next wafer (the wafer in wait) (FIG. 2: S115).

Receiving the signal, the apparatus operation control unit 105 refers to the changed process condition table 300, acquires the process condition corresponding to the wafer ID “WAFER04” and performs the treatment on the wafer according to the acquired condition (FIG. 2: S104).

When the treatment on the wafer having the wafer ID “WAFER04” starts, the wafer is treated according to the newly received process condition, namely the changed CH1 recipe parameter 608a (the processing time “9 sec” and CH temperature “98° C.”) and changed CH2 recipe parameter 608b (the processing time “13 sec” and CH temperature “90° C.”).

On the other hand, when no new lot process condition table is received while the apparatus operation control unit 105 is waiting, in other words before the timeout period ends (FIG. 2: S109, S110 NO), the apparatus recipe control unit 104 sends to the apparatus operation control unit 105 a signal for performing the treatment on the next wafer (the wafer in wait) (FIG. 2: S115). In such a case, the apparatus operation control unit 105 performs the treatment on the wafer according to the process condition corresponding to the wafer ID “WAFER04” (FIG. 2: S104).

In this case, the process condition for the wafer ID “WAFER04” is the previously received process condition, namely the CH1 initial recipe parameter 308a (the processing time “11 sec” and CH temperature “105° C.”) and CH2 initial recipe parameter 308b (the processing time “14 sec” and CH temperature “88° C.”); the treatment of the wafer is performed according to this condition.

As described above, regardless of the process condition being changed or not, once the treatment of one wafer is completed, the apparatus recipe control unit 104 sends the execution table corresponding to the finding of executed process condition (here, the execution table corresponding to the wafer ID “WAFER04”) to the external apparatus 100 via the apparatus online control unit 102 (FIG. 2: S105).

Furthermore, the apparatus drive unit 106 transfers the wafer having the wafer ID “WAFER04” from the second chamber to the carrier and rewrites (updates) the processing state table stored in the wafer object control unit 103 (FIG. 2: S106). The wafer object control unit 103 sends the updated processing state table to the external apparatus 100 via the online control unit 102 (FIG. 2: S107).

After a given number of wafer treatment operations (a total of 24 times), the apparatus drive unit 106 executes all process conditions for the wafer IDs stored in the process condition table 300. The treated wafers are all returned to their original positions in the carrier and the treatment of the lot is completed (FIG. 2: S108 YES).

As described above, the semiconductor manufacturing apparatus of this embodiment comprises a unit configured to determine whether or not the previously received wafer process condition can be changed to the newly received wafer process condition based on the wafer operation progress when it receives a new process condition table having the wafer identification information all equal to the wafer identification information in the previously received process condition table and a unit configured to change the wafer process condition to the newly received wafer process condition when any wafer process condition is changeable.

In this way, when there are any untreated wafers among a given number of wafers in the previously received process condition table based on the wafer operation progress, it is deemed that their wafer process conditions are changeable and changed to the newly received wafer process conditions. Therefore, the process condition for wafers of which the processing state changes in real time can be changed on a wafer basis based on the wafer operation progress although the process condition table can be changed only on a lot basis in the conventional art. For example, a process condition based on new wafer measurements (optimized process condition) can immediately be reflected in the treatment of wafers in the lot in process.

Consequently, the quality of treated wafers is improved and the production yield, or a ratio of not-defective wafers to all treated wafers, can be increased. Furthermore, the process condition can be changed on a wafer basis; a small change (fine adjustment) in the process condition can easily be made.

In the first embodiment, when the apparatus recipe control unit receives a new lot process condition table (changed process condition table) while the apparatus operation control unit is in wait, the apparatus recipe control unit determines whether or not the wafer IDs in the previously received process condition table are all equal to the wafer IDs in the newly received changed process condition table. However, in another possible configuration, the apparatus recipe control unit performs the above determination when it receives a changed process condition table at some other time, for example, while the apparatus operation control unit is treating a wafer.

### Second Embodiment

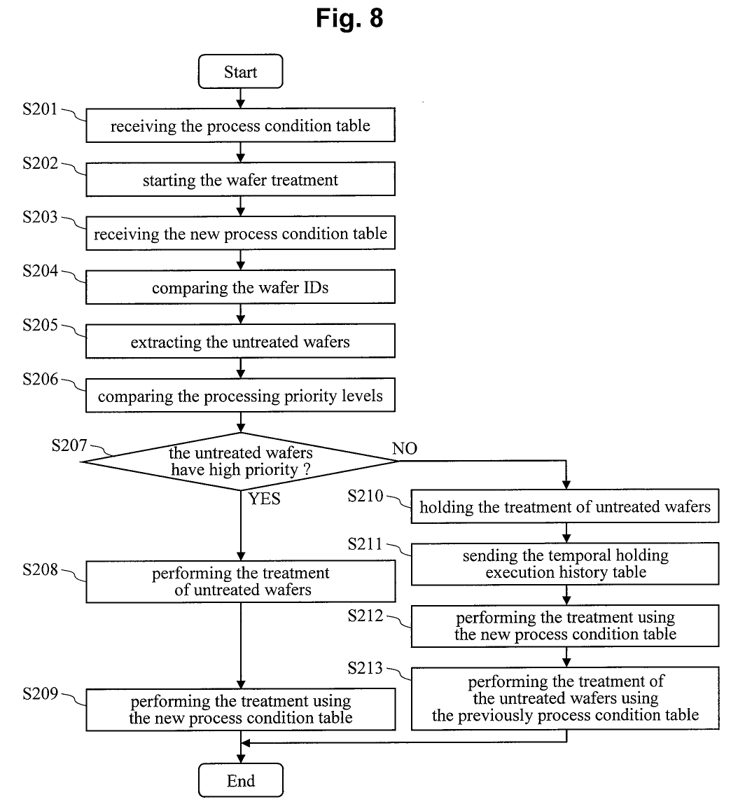

Next, how a semiconductor manufacturing apparatus of a second embodiment allows for interruption and priority execution of a new lot process condition table having high priorities when it receives the new lot process condition table from the external apparatus 100 will be described with reference to FIGS. 8 to 11.

The second embodiment is different from the first embodiment in that it is determined which has the higher priority. Having the same configuration as the first embodiment, the second embodiment will be described with reference to the drawings that are referred to for the description of the first embodiment (FIGS. 1 to 7).

Before the apparatus operation control unit 105 of the semiconductor manufacturing apparatus 101 retrieves a wafer from multiple wafers in the carrier and treat the wafer one by one, a process condition table set by a user and in which the wafers in a lot are associated with process conditions is sent from the external apparatus 100 to the apparatus online control unit 102 of the semiconductor manufacturing apparatus 101.

When the apparatus online control unit 102 receives the process condition table, the apparatus recipe control unit 104 receives the process condition table via the apparatus online control unit 102 and keeps (stores) the process condition table (FIG. 8: S201).

As shown in FIG. 3, in the process condition table 300, the wafer ID 301, the recipe ID 302, the waiting call 303, the processing priority level 304, the timeout period 305, the first chamber (CH1) initial recipe parameter 306 and the second chamber (CH2) initial recipe parameter 307 are associated and stored.

The information stored in the processing priority level 304 can be any information as long as it indicates the priority (preference). For example, when the priority is given in the alphabetical order, the letter “A” provides the information of highest priority and the subsequent letters “B” and “C” provide the information of lower priorities. This can be modified, for example, by using the numbers where appropriate instead of the alphabet. The processing priority level 304 allows the apparatus recipe control unit 104 to determine which wafer should be given priority in treatment before the wafers are treated.

Receiving the process condition table 300, the apparatus recipe control unit 104 refers to the waiting call 303 corresponding to the wafer ID “WAFER01” in the process condition table 300 and determines whether or not the transfer of the wafer to the chamber is held. The same procedure as in the first embodiment is repeated from the determination of the waiting call to the performance of the treatment of the wafer (FIG. 8: S202).

When a new process condition table set by a user for a lot that is different from the lot of the process condition table 300 containing the wafer ID of a wafer currently in process, namely a process condition table (new process condition table) having wafer IDs different from those in the process condition table 300 is sent from the external apparatus 100 to the apparatus recipe control unit 104, the apparatus recipe control unit 104 temporarily stores the new process condition table (FIG. 8: S203).

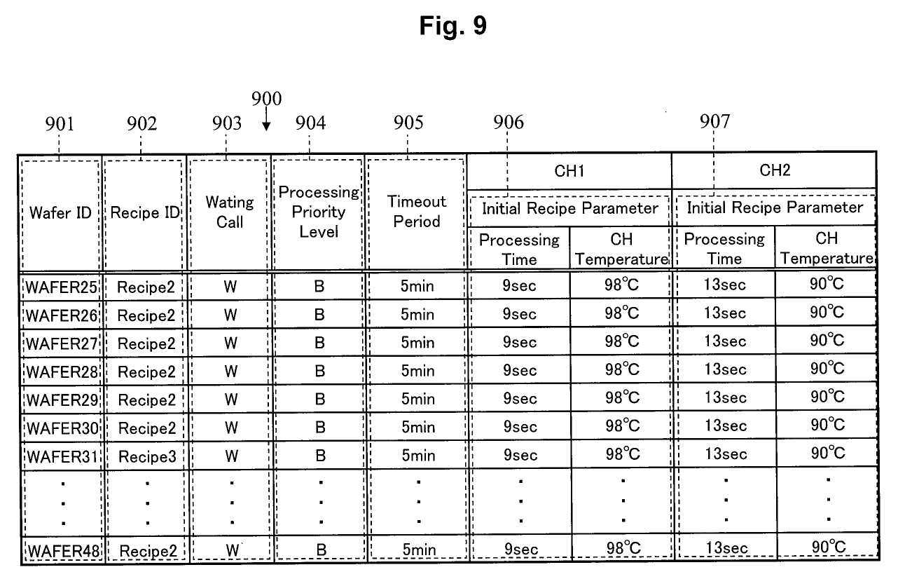

As shown in FIG. 9, a process condition table 900 has the same structure as the process condition table 300, in which a wafer ID 901, a recipe ID 902, a waiting call 903, a processing priority level 904, a timeout period 905, a first chamber (CH1) initial recipe parameter 906 and a second chamber (CH2) initial recipe parameter 907 are associated and stored.

The major difference between the new process condition table 900 and process condition table 300 is the wafer IDs; they are process condition tables for different lots. The process condition table 300 contains the wafer IDs 301 “WAFER01” to “WAFER24” and the new process condition table 900 contains the wafer IDs 901 “WAFER25” to “WAFER48”. The processing priority levels 904 corresponding to the wafer IDs 901 in the new process condition table 900 are all the priority “B”.

Temporarily storing the new process condition table 900, the apparatus recipe control unit 104 determines whether or not the wafer IDs 301 in the previously received process condition table 300 are all equal to the wafer IDs 901 in the new process condition table 900 (FIG. 8: S204). Here, the wafer IDs in the tables are compared with each other to find out the same wafer IDs.

A method of determining whether or not the lot corresponding to the new process condition table and the lot corresponding to the previously received process condition table are the same can be realized, for example, by providing lot IDs that are identifiers for identifying the lots to the process condition table and new process condition table, comparing the lot IDs of the process condition table and new process condition table, and determining whether or not the lot corresponding to the new process condition table and the lot corresponding to the previously received process condition table are the same.

As described above, the wafer IDs are different between the process condition table 300 and new process condition table 900. Therefore, the apparatus recipe control unit 104 deems that the process condition table 300 and new process condition table 900 are process condition tables for different lots. Furthermore, the apparatus recipe control unit 104 checks the processing state table stored in the wafer object control unit 103 and confirms the wafer operation progress (FIG. 8: S205).

When the wafer IDs in the process condition table are all equal to the wafer IDs in the new process condition table, the same procedure as in the first embodiment is repeated and, therefore, the explanation is omitted.

For example, when the symbol “o” is associated and stored in the transfer field “carrier before treatment” of the processing state table for the wafer IDs “WAFER04” to “WAFER24,” the apparatus recipe control unit 104 deems that the wafers having these wafer IDs are untreated.

Furthermore, the apparatus recipe control unit 104 compares the priorities in the processing priority levels corresponding to the wafer IDs of the untreated wafers (for example “A”, “B”, etc.) with the priorities in the processing priority levels corresponding to all wafer IDs in the new process condition table and determines which wafer should be given priority in treatment (FIG. 8: S206, S207).

As a result of the priority comparison, when all priorities corresponding to the wafer IDs of the untreated wafers in the process condition table 300 are higher than or equal to all priorities corresponding to the wafer IDs in the new process condition table, the apparatus recipe control unit 104 deems that the wafers in the process condition table 300 should have priority in treatment. Then, the apparatus recipe control unit 104 controls the apparatus operation control unit 105 to treat all wafers corresponding to the process condition table 300 and then treat the wafers corresponding to the new process condition table 900 (FIG. 8: S207 YES, S208).

For example, as shown in FIGS. 3 and 9, it is assumed that the priority “B” is associated and stored in the processing priority level 304 for all of the wafer IDs “WAFER04” to “WAFER24” of the untreated wafers in the process condition table 300 and the priority “B” is associated and stored in the processing priority level 904 for the wafer IDs 901 “WAFER25” to “WAFER48” in the process condition table 900. In such a case, the priorities corresponding to the wafer IDs of the untreated wafers are equal to the priorities of all wafer IDs in the new process condition table 900; therefore, the apparatus recipe control unit 104 deems that the untreated wafers should have priority in treatment.

The same procedure applies when the associated and stored priorities of the wafer IDs “WAFER04” to “WAFER24” of the untreated wafers (for example “A”) are higher than the priorities of all wafer IDs “WAFER25” to “WAFER48” in the new process condition table 900 (for example “B”).

Furthermore, some of the priorities corresponding to the wafer IDs of the untreated wafer in the previously received process condition table are higher than or equal to all priorities of the wafer IDs in the new process condition table, the apparatus recipe control unit 104 deems that the wafers in the process condition table should have priority in treatment and controls the apparatus operation control unit 105 to treat all wafers in the previously received process condition table and then treat the wafers in the new process condition table.

The same procedure applies when some of the associated and stored priorities of the wafer IDs “WAFER04” to “WAFER24” of the untreated wafers (for example some of the priorities are “A”) are higher than or equal to all priority of the wafer IDs “WAFER25” to “WAFER48” in the new process condition table (for example “A” and “B”).

The apparatus operation control unit 105 continues to treat the untreated wafers in the process condition table 300 and then treats the wafers in the new process condition table 900 (FIG. 8: S208, S209). More specifically, after a given number of wafer treatment operations, the apparatus drive unit 106 carries out the carrier in which all wafers in the process condition table 300 are kept, and then treats the wafers in the new process condition table 900. After the wafers in the new process condition table 900 are all treated, the apparatus drive unit 106 carries out the carrier in which all wafers are kept, whereby the treatment of the two lots is completed.

On the other hand, when all priorities of the wafer IDs of the untreated wafers in the process condition table 300 are lower than all priorities of the wafer IDs in the new process condition table, the apparatus recipe control unit 104 deems that the wafers in the new process condition table 900 should have priority in treatment and sends to the apparatus operation control unit 105 a signal for holding the treatment of untreated wafers in the process condition table 300 (FIG. 8: S207 NO, S210).

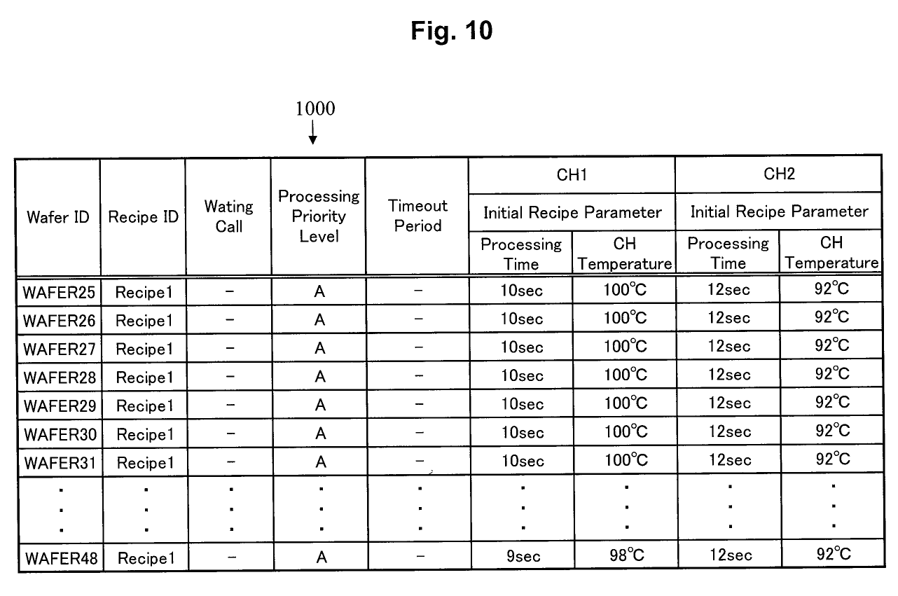

For example, this is the case in which the associated and stored priorities of the wafer IDs “WAFER04” to “WAFER24” of the untreated wafers in the process condition table 300 shown in FIG. 3 (for example “B”) are lower than the priorities of the wafer IDs “WAFER25” to “WAFER48” in a new process condition table 1000 shown in FIG. 10 (for example “A’).

When there is any wafer in treat at the time of reception of the signal, the apparatus operation control unit 105 completes the treatment and transfer of the wafer. When there is any wafer in transfer at the time of reception of the signal, the apparatus operation control unit 105 completes the transfer of the wafer. After completing the transfer of the wafer, the apparatus operation control unit 105 holds the transfer of the subsequent untreated wafer in response to the signal.

Furthermore, the apparatus recipe control unit 104 sends a temporal holding execution history table that is a table indicating that there is an wafer ID temporarily held to the external apparatus 100 via the apparatus online control unit 102 (FIG. 8: S211). The temporal holding execution history table corresponds to the finding of temporarily held wafer.

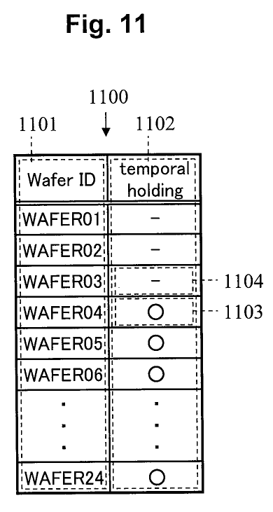

As shown in FIG. 11, a wafer ID 1101 and a temporal holding field 1102 indicating the operation temporarily held are associated and stored in a temporary held operation execution history table 1100. A symbol “o” 1103 is associated and stored in the temporal holding fields 1102 corresponding to the wafer IDs of which the treatment is temporarily held (the temporal holding fields 1102 corresponding to the wafer IDs “WAFER04” to “WAFER24”) and a symbol “−” 1104 is associated and stored in the temporal holding fields 1102 corresponding to the wafer IDs of which the treatment is not temporarily held (the wafer IDs of which the treatment was performed).

The external apparatus 100 displays the received temporary held operation execution history table 1100 to a user (other semiconductor manufacturing apparatuses). With the above configuration, when the apparatus recipe control unit 104 allows for interruption of a new lot process condition table, a user or other semiconductor manufacturing apparatuses can easily know the wafer IDs of which the treatment is temporarily held.

Then, the apparatus recipe control unit 104 sends to the apparatus operation control unit 105 a signal for giving priority in treatment to the wafers in the new process condition table 1000. In response to the signal, the apparatus operation control unit 105 temporarily withdraws the carrier in which the untreated wafer are kept (the carrier corresponding to the previously received process condition table 300) to some other place where it does not interfere with the transport of another carrier and transports the carrier corresponding to the new process condition table 1000 into the apparatus drive unit 106 using a robot and the like.

After finishing the transport of the carrier corresponding to the new process condition table 1000, the apparatus operation control unit 105 refers to the new process condition table 1000 temporarily stored in the apparatus recipe control unit 104 and performs the treatment of wafers in the new process condition table 1000 (FIG. 8: S212).

After a given number of wafer treatment operations, the apparatus operation control unit 105 completes the treatment of wafers in the new process condition table 1000 and the apparatus drive unit 106 carries out the carrier in which all wafers corresponding to the new process condition table 1000 are kept. The apparatus drive unit 106 further returns the carrier withdrawn earlier in which the untreated wafers are kept to the wafer treatment position and performs the treatment on the untreated wafers based on the process condition table 300 (FIG. 8: S213).

After a given number of wafer treatment operations, the apparatus drive unit 106 carries out the carrier in which all wafers corresponding to the process condition table 300 are kept.

As described above, the semiconductor manufacturing apparatus of this embodiment comprises a unit configured to compare the priorities associated with the identification information of untreated wafers among a given number of wafers in the previously received process condition table with the priorities associated with the wafer identification information in the newly received process condition table based on the wafer operation progress when it receives a new process condition table having wafer identification information all different from the wafer identification information in the previously received process condition table and a unit configured to give priority in execution to the process condition table having the identification information of higher priority wafers as a result of the priority comparison.

In this way, when the semiconductor manufacturing apparatus receives a new process condition table for a lot different from the previously received lot, it gives priority in execution to the process condition table for the lot having wafers of higher priorities. Therefore, when there are any wafers to which a given process condition should immediately be applied or wafers of which the treatment is urgent, the semiconductor manufacturing apparatus allows for interruption and prompt execution of the process condition table for the lot to which such wafers.

Furthermore, the treatment of wafers having lower priorities can temporarily be held so that the wafers having higher priorities are treated first in a semiconductor manufacturing apparatus specified by a user. In this way, variations among semiconductor manufacturing apparatuses can be prevented and the treatment intended by a user can be done on wafers. In addition, delay in the lead time of wafers having high priorities is eliminated and urgent wafer treatment can promptly be done.

In the second embodiment, the priorities of untreated wafers corresponding to the process condition table and the priorities of wafers corresponding to the new process condition table are compared with each other and, when all priorities corresponding to the wafer IDs of untreated wafers in the process condition table (for example “B”) are lower than all priorities corresponding to the wafer IDs in the new process condition table (for example “A”), the apparatus recipe control unit 104 deems that the wafers in the new process condition table should have priority in execution. However, other configurations can be used.

For example, when some of the priorities corresponding to the wafer IDs of untreated wafers (for example some priorities are “B” and the others are “A”) are lower than all priorities corresponding to the wafer IDs in the new process condition table (for example “A”) (in other words, some of the priorities corresponding to the wafer IDs of untreated wafers are higher than or equal to all priorities corresponding to the wafer IDs in the new process condition table), the apparatus recipe control unit gives priority in treatment to the untreated wafers having priorities higher than or equal to all priorities (for example “A’) corresponding to the wafer IDs in the new process condition table among the untreated wafers corresponding to the process condition table (for example, mixed priorities of “A” and “B”). Furthermore, after all such untreated wafers are treated, the apparatus recipe control unit can temporarily hold the treatment of untreated wafers having lower priorities in the process condition table (for example the priority “B”) and gives priority in treatment to the wafers corresponding to the new process condition table (for example the priority “A”). When the above configuration is used, needless to say, the symbol “o” is given only to the wafer IDs of untreated wafers in the return table.

Furthermore, the condition can automatically be set by the external apparatus with which a user sets conditions based on an algorithm specified in advance and the treatment results of wafers in the same lot.

The above described embodiments do not restrict the technical scope of the present invention and, in addition to what is described above, various modifications and applications can be made without departing from the technical scope of the present invention.

In the first embodiment, the process condition table and changed process condition table in which the waiting call and processing priority level are associate and stored are provided. The processing priority level field can be omitted where necessary.

In the second embodiment, the process condition table and new process condition table in which the waiting call and processing priority level are associate and stored are provided. The waiting call field can be omitted where necessary. For example, a switch configured to switch to the operation in which only the processing priority level is taken into account by pressing down a given operation key can additionally be provided.

In the first and second embodiments, the priority is determined in accordance with the processing priority level. For example, the priority can be determined in accordance with the recipe ID corresponding to the wafer ID instead of the processing priority level. For example, the priority is increased in the order of recipe ID number. The apparatus recipe control unit compares the recipe number in the process condition table in question with the recipe number in the changed process condition table or new process condition table for determination.

Furthermore, the means used in the first and second embodiments can be combined with each other.

Furthermore, a program for having a computer execute a part of or all of the above described procedures performed by each unit of the semiconductor manufacturing apparatus may be provided to related parties or third parties via electrical communication lines such as the internet or by storing the program on a computer readable recording medium. For example, when the program instructions are expressed with electrical signals, optical signals, magnetic signals or the like and those signals are sent on a carrier wave, it is possible to provide those programs via transmission media such as coaxial cable, copper wiring, optical fibers or the like. In addition, as the computer readable recording medium, it is possible to use optical media such as CD-ROM, DVD-ROM, and the like, magnetic media such as flexible disk, or semiconductor memory such as flash memory or RAM.

As described above, the semiconductor manufacturing apparatus of the present invention is useful for improving the wafer quality, increasing the wafer production yield, and reducing the increasing semiconductor manufacturing apparatus cost, allows the process condition to be changed on a wafer basis when a new lot process condition received, and allows for interruption and priority execution of new process conditions having higher priorities.

What is claimed is:

1. A semiconductor manufacturing apparatus in which a given number of wafers constitute a lot and the given number of wafers is treated based on a lot process condition table obtained from an external apparatus, comprising:
a unit configured to receive a new lot process condition table containing wafer process conditions corresponding to wafer identification information each of wafers in one lot and having the wafer identification information all equal to wafer identification information in a previously received lot process condition table for the lot;
a unit configured to determine whether or not a previously received wafer process condition in the previously received lot process condition table can be changed to a newly received wafer process condition in the new lot process condition table based on a wafer operation progress indicating which wafer is treated or untreated among the given number of wafers in the previously received lot process condition table; and
a unit configured to change the previously received wafer process condition to the newly received wafer process condition when any wafer process condition is changeable.

2. A semiconductor manufacturing apparatus according to claim 1, further comprising a unit configured to send a finding of changeability to the external apparatus after it is determined whether or not the previously received wafer process condition can be changed to the newly received wafer process condition.

3. A semiconductor manufacturing apparatus according to claim 1, further comprising:
a unit configured to determine whether or not a transfer of a wafer to a process chamber is held before the wafer is treated based on a waiting call that is information associated with the wafer identification information of the wafer in the lot process condition table and indicating that the transfer of the wafer to the process chamber is held or not; and
a unit configured to hold the transfer of the wafer to the process chamber for a given period of time associated with the wafer identification information of the wafer when it is determined that the transfer of the wafer to the process chamber is held.

4. A semiconductor manufacturing apparatus according to claim 2, further comprising:
a unit configured to determine whether or not a transfer of a wafer to a process chamber is held before the wafer is treated based on a waiting call that is information associated with the wafer identification information of the wafer in the lot process condition table and indicating that the transfer of the wafer to the process chamber is held or not; and
a unit configured to hold the transfer of the wafer to the process chamber for a given period of time associated with the wafer identification information of the wafer when it is determined that the transfer of the wafer to the process chamber is held.

5. A semiconductor manufacturing apparatus in which a given number of wafers constitute a lot and the given number of wafers is treated based on a lot process condition table obtained from an external apparatus, comprising:
a unit configured to receive a new lot process condition table containing wafer process conditions corresponding to wafer identification information each of wafers in one lot and having the wafer identification information all different from wafer identification information in a previously received lot process condition table for a lot;
a unit configured to compare a priority information indicating a priority of a wafer treatment associated with the wafer identification information of untreated wafers among the wafers in the previously received lot process condition table with the priority information associated with the wafer identification information of wafers in the newly received lot process condition table based on a wafer operation progress indicating which wafer is treated or untreated among the given number of wafers in the previously received lot process condition table; and
a unit configured to give priority in execution to the lot process condition table having the wafer identification information of higher priority wafers as a result of the priority information comparison.

6. A semiconductor manufacturing apparatus according to claim 5, further comprising a unit configured to temporarily hold a treatment in progress based on the previously received lot process condition table and to give priority in execution to the newly received lot process condition table when the priority information comparison results show that the lot process condition table having the wafer identification information of higher priority wafers is the newly received lot process condition table.

7. A semiconductor manufacturing apparatus according to claim 5, further comprising a unit configured to send a finding of temporarily held wafers to the external apparatus when the treatment in progress based on the previously received lot process condition table is held.

8. A semiconductor manufacturing apparatus according to claim 6, further comprising a unit configured to send a finding of temporarily held wafers to the external apparatus when the treatment in progress based on the previously received lot process condition table is held.

9. A semiconductor manufacturing apparatus according to claim 1, further comprising a unit configured to send a finding of executed process condition to the external apparatus for each basis after a given treatment is performed on a wafer among the given number of wafers in a lot.

10. A semiconductor manufacturing apparatus according to claim 5, further comprising a unit configured to send a finding of executed process condition to the external apparatus for each basis after a given treatment is performed on a wafer among the given number of wafers in a lot.
